(19) United States
(12) Patent Application Publication
(10) Pub. No.: US 2012/0104671 A1
(43) Pub. Date: May 3, 2012

(54) Spring Pack

(76) Inventor: Rui Novo, North York (CA)

(21) Appl. No.: 13/283,157

(22) Filed: Oct. 27, 2011

Related U.S. Application Data
(60) Provisional application No. 61/407,114, filed on Oct. 27, 2010.

(51) Int. Cl. F16F 3/00

(52) U.S. Cl. 267/162

(57) ABSTRACT

There is disclosed a spring pack for use with an injection mold to ensure an effective sealing force is applied to the injection mold. The spring pack includes a plurality of coned disk springs mounted in a housing, each cone disk spring having a concave side, a convex side, a central opening, and a maximal deflection distance. The coned disk springs are coaxially mounted about a central pin. The coned disks are mounted in series such that the spring pack has an effective deflection distance equal to the sum total of the maximal deflection distances of the conical springs. The housing and the coned disk springs are configured such that the sealing force applied to the spring pack is transmitted through the spring pack entirely by the springs.

### CROSS REFERENCE TO RELATED APPLICATION This application claims priority from U.S. provisional application No. 61/407,114 filed Oct. 27, 2010, which is incorporated herein by reference.

### FIELD OF THE INVENTION

The invention relates generally to spring packs for use with hot runners, manifolds and plastic injection molds.

### BACKGROUND OF THE INVENTION

Injection molding machines operate by forcing two mold halves together and then injecting melted plastic into the mold cavity. In order to ensure that there are no leaks in the mold, the mold halves must be brought together with sufficient force to keep the mold halves sealed together. Since the melt being injected into the mold cavity is quite hot, the mold halves, together with the other constituent parts of the mold system such as the hot runner and the like, will heat up and expand. To prevent over stressing of the mold, the sizing of the mold components, hot runner and the like have to be carefully controlled to ensure that there is a tight seal between the mold halves when the mold is heated up by the presence of the hot melt. However, when the mold components are still cool, a tight seal may be lacking because the constituent parts of the molding system have not reached their operational temperature. A spring pack may be used to urge parts together to ensure that the mold components are properly sealed and to prevent over stressing of the mold when the mold components are at operation temperatures. Spring packs can be bulky and must be custom designed for each mold. Changing a melt channel size or even changing the nature of the melt may require different springs packs to be used since different melts operate at different temperatures and therefore require different loading conditions. An improved spring pack which is generally applicable over a wide variety of different melt temperatures and channel sizes is therefore required.

### SUMMARY OF THE INVENTION

The present invention is a spring pack for use with an injection mold to ensure an effective sealing force is applied to the injection mold. The spring pack includes a plurality of coned disk springs mounted in a housing, each cone disk spring having a concave side, a convex side, a central opening, and a maximal deflection distance. The coned disk springs are coaxially mounted about a central pin. The coned disks are mounted in series such that the spring pack has an effective deflection distance equal to the sum total of the maximal deflection distances of the conical springs. The housing and the coned disk springs are configured such that the sealing force applied to the spring pack is transmitted through the spring pack entirely by the springs.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a cross sectional view of a spring pack made in accordance with the present invention mounted in a hot runner manifold.

FIG. 2 is a cross sectional view of the spring pack shown in FIG. 1 in its fully expanded position.

FIG. 3 is a cross sectional view of the spring pack shown in FIG. 1 in its fully contracted position.

FIG. 4 is an isometric view of the spring pack shown in FIG. 2.

FIG. 5 is a cross sectional view of a conical spring used in constructing a spring pack made in accordance with the present invention.

FIG. 6 is a cross sectional view of two conical springs coupled together in series.

In the drawings like characters of reference indicate corresponding parts in the different figures.

### DETAILED DESCRIPTION OF THE INVENTION

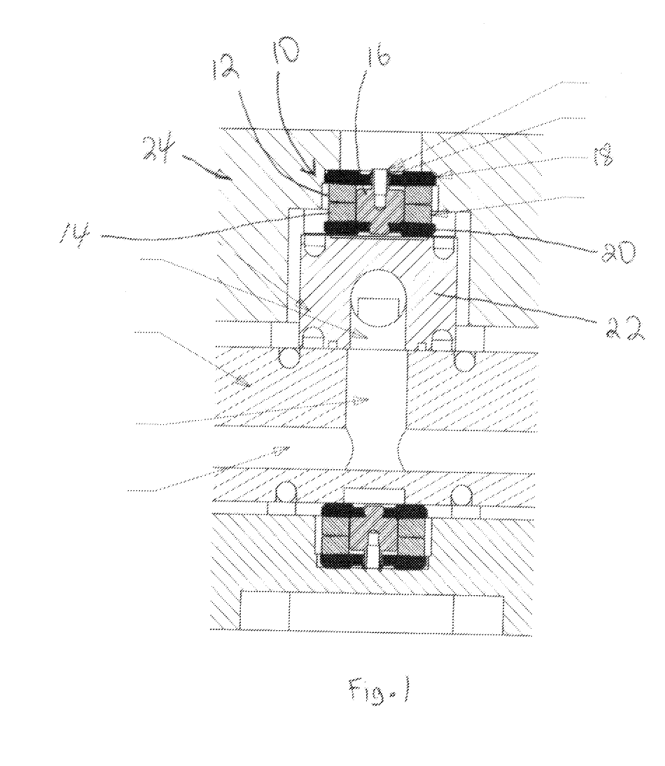

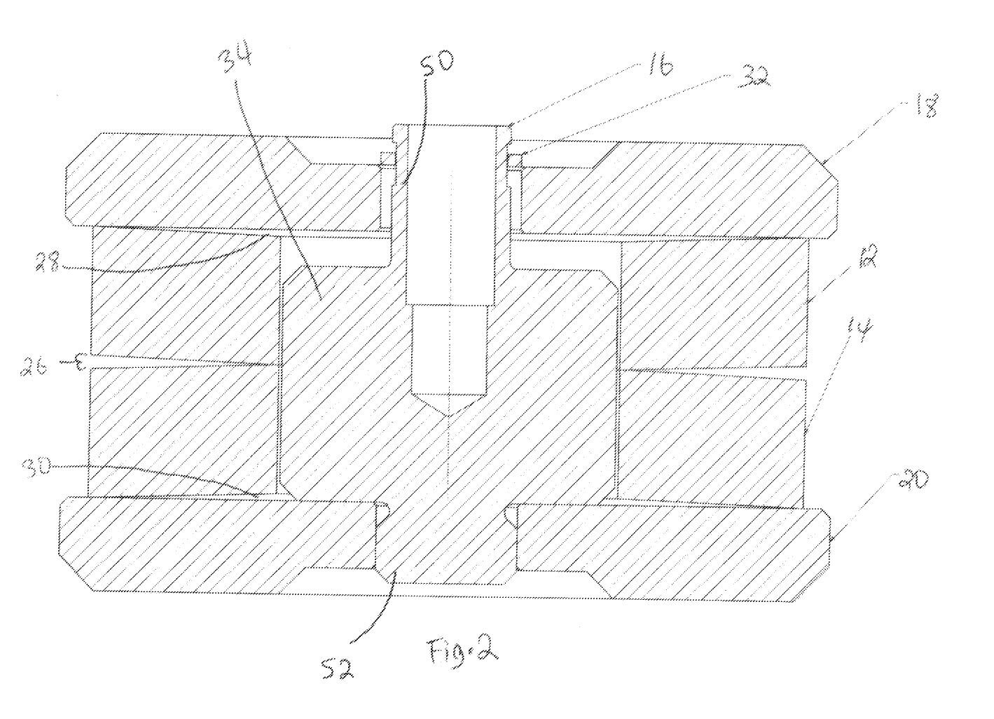

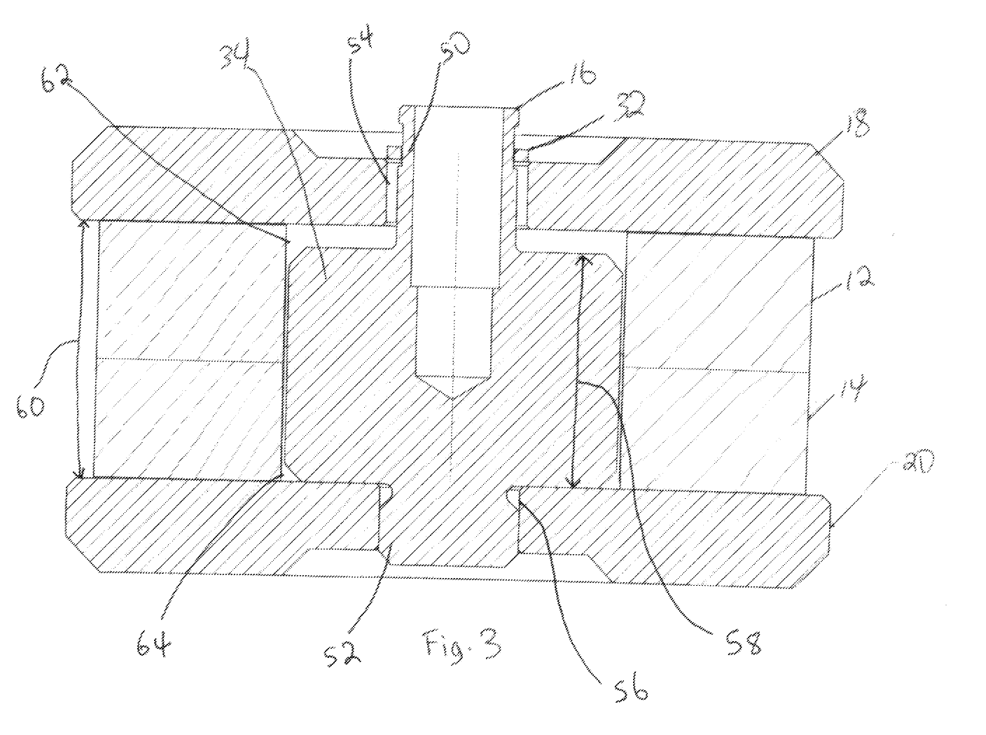

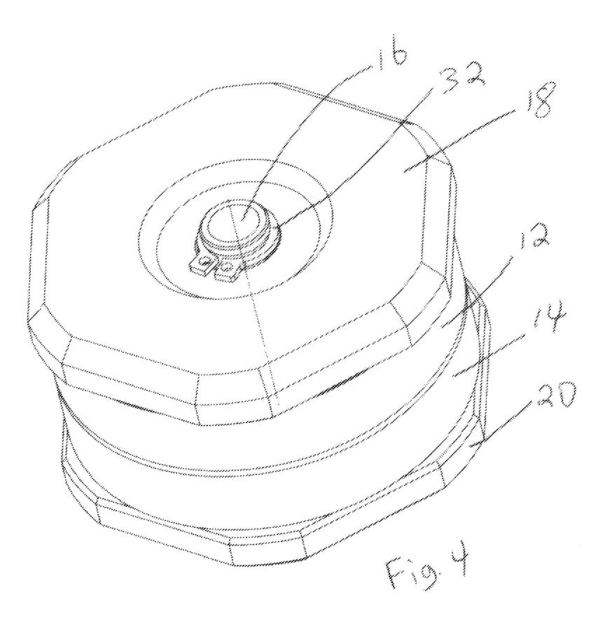

Referring firstly to FIG. 1, a spring pack made in accordance with the present invention is shown generally as item 10 and includes a pair of coned disk springs (belleville washers) 12 and 14 mounted to post 16 between washers 18 and 20. Spring pack 10 is placed in a mold, hot runner manifold or the like to ensure that there is sufficient sealing pressure applied to the mold components even at room temperature. In the example shown in FIG. 1, spring pack 10 is placed between manifold backing plate 24 and cross manifold 22. As best seen in FIG. 2, springs 12 and 14 are conical springs which are coaxially mounted adjacent one another on post 16 between washers 18 and 20. Springs 12 and 14 are mounted in series such that the convex surfaces of the two springs face each other and the amount of total deflection of the springs is maximized. Springs 12 and 14 are made of spring steel and have a thickness of several millimeters to ensure that the spring pack is capable of generating a strong biasing force. The amount of maximal deflection is the sum total of gap 26 between the springs and gaps 28 and 30 between the springs and the washers. Springs 12 and 14 are able to flex between a fully expanded (i.e. relaxed position) as shown in FIG. 2 to a fully contracted (tensioned) position as shown in FIG. 3.

When the spring pack is in its fully contracted position, the force applied between the washers 18 and 20 is carried only by the springs 12 and 14 and not by post 16. Central portion 34 of post 16 is dimensioned such that the central portion of the post does not transfer any force between washers 18 and 20 and all of the force applied to the spring pack is carried by springs 12 and 14. In order to prevent springs 12 and 14 from slipping off post 16, snap ring 32 is clipped to the end of post 16 to prevent the disassembly of the spring pack. Post 16 essentially floats within washers 18 and 20. Post 16 has opposite ends 50 and 52 which are dimensioned to fit within apertures 54 and 56 of washers 18 and 20, respectively, and the post can move back and forth between the washers. Central portion 34 of post 16 is wider than ends 50 and 52 and it is wider than openings 54 and 56 such that the post cannot slip out from between the washers. Central portion 34 has a diameter which is slightly less than the internal diameter of central opening 62 of spring 12 and central opening 64 of spring 14. This ensures that the two springs can flex freely when mounted to the central portion. Central portion 34 has a thickness 58 which is less than the combined thickness 60 of springs 12 and 14 when the two springs are in their fully contracted position. Since post 16 floats within washers 18 and 20 and since the thickness of central portion 34 of the post is less than the combined thicknesses of the springs, all of the force exerted by the mold components which passes through the spring pack, passes entirely through the springs.

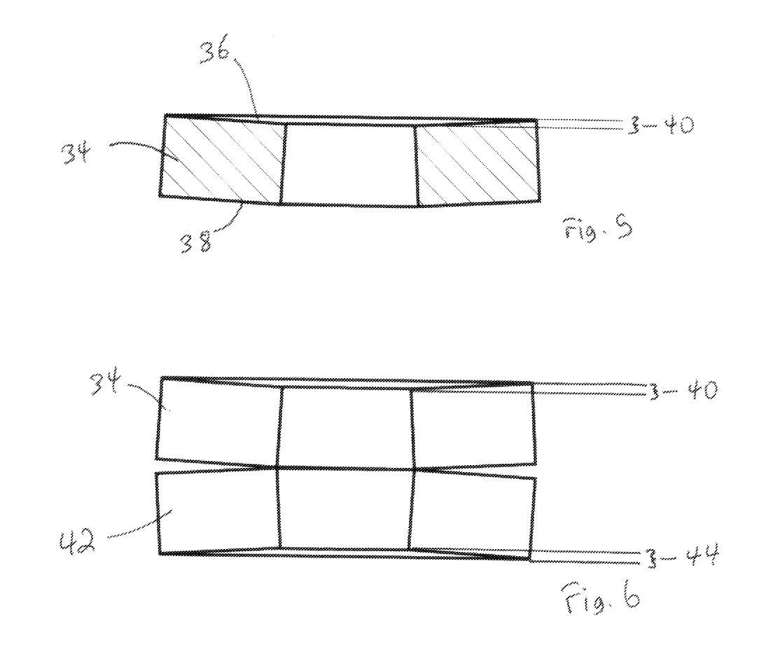

Referring now to FIGS. 5 and 6, each conical spring used in the present invention, shown generally as 34, has a concave surface 36 and a convex surface 38. Each spring 34 has a deflection distance 40 which is the maximum distance by which the spring will contract when sufficient force is applied to the spring. When an additional identical conical spring 42 is coupled to spring 34 such that their respective convex surfaces are oriented towards each other, the maximal deflection distance of the two combined springs is a sum of deflection distance 40 (for spring 34) and deflection distance 44 (for spring 42). The same result would be achieved if the two springs were oriented such that their concave surfaces are oriented towards each other. One or two additional springs could be added to the spring pair shown in FIGS. 5 and 6, provided the additional springs are coupled to springs 34 and 42 with the concave surfaces of the additional springs oriented towards springs 34 or 42.

Referring back to FIG. 1, while spring pack 10 is shown with a pair of coned disk springs, it will be appreciated that several coned disk springs may be added in series in order to increase the total amount of deflection. In the embodiment shown in FIGS. 1 and 2, the coned disk springs are coaxially aligned with the convex surfaces of the adjacent coned springs facing each other. However, it is also possible to arrange the coned disk springs together with their concave surfaces facing each other. In either orientation, the coned disk springs are said to be mounted in series because the total deflection of the springs is a sum of the deflection distances of each spring. Since the springs are added together in series and not in parallel, the deflection force applied by the springs in series is substantially equal to the deflection force applied by each of the springs. This allows for the possibility of increasing the maximal total deflection of the spring pack by simply adding more coned disk springs in series without changing the force applied by the spring pack. This allows for changes to be made to the mold components without worrying as much about the correct sizing because the added deflection allows for greater leeway in sizing mold components. The larger deflection also permits the spring packs to provide sufficient sealing force even when the mold components are at room temperature.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

1. A spring pack for use with an injection molding machine, the spring pack comprising at least two coned disk springs each having a concave and a convex side and a central opening, the coned disk springs being coaxially mounted in series about a central pin between a pair of washers, the coned disk springs being configured to be movable between a relaxed position wherein space gaps exist between the coned disk springs and between the coned disk springs and the washers and a fully compressed position wherein there is no space gap between the coned disk springs and between the coned disk springs and the washers, the central pin, washers and the coned disk springs being further dimensioned and configured such that any force applied to the disks to urge the disks together is transmitted entirely by the springs.

2. A spring pack for use with an injection mold to ensure an effective sealing force is applied to the mold, the spring pack comprising a plurality of coned disk springs mounted within a housing, each coned disk spring having a concave side, a convex side, a central opening, and a maximal deflection distance, the coned disk springs being coaxially mounted about a central pin, the coned disks being mounted in series such that the spring pack has an effective deflection distance equal to the sum total of the maximal deflection distances of the conical springs, the housing and the coned disk springs being further dimensioned and configured such that the sealing force applied to the spring pack is transmitted through the spring pack entirely by the coned disk springs.

3. The spring pack of claim 2 wherein the coned disk springs and central pin are all coaxially mounted between a pair of washers, each of the washers having a central opening, the pin having opposite ends configured to pass through the central openings of the washers.
